(19) United States
(12) Patent Application Publication
(10) Pub. No.: US 2023/0373548 A1
(43) Pub. Date: Nov. 23, 2023

(54) CHILD CARRIAGE

(71) Applicant: WONDERLAND SWITZERLAND AG, Steinhausen (CH)

(72) Inventor: Jialiang YUAN, Dongguan (CN)

(21) Appl. No.: 18/322,504

(22) Filed: May 23, 2023

(30) Foreign Application Priority Data
May 23, 2022 (CN) 202210565123.4

(51) Int. Cl. B62B 7/06; B62B 7/10; B62B 7/14

(52) U.S. Cl. CPC B62B 7/062; B62B 7/064; B62B 7/10; B62B 7/142

(57) ABSTRACT

The present disclosure relates to a child carrier, including a frame and a lower leg resting assembly. The frame has a folded state. The lower leg resting assembly is connected to the frame. When the frame is in the folded state, the lower leg resting assembly is used as a carrying handle for lifting and pulling the frame.

### CROSS REFERENCE TO RELATED APPLICATION

This application claims priority to Chinese patent application No. 2022105651234, filed on May 23, 2022, the entire content of which is incorporated herein by reference.

### TECHNICAL FIELD

The present disclosure relates to the technical field of child carriers, and in particular, to a child carrier.

### BACKGROUND

At present, to facilitate portability, a foldable child carrier, such as a stroller, on the market, is generally equipped with an additional carrying device or carrying handle to facilitate consumers to carry a folded frame after being folded, but this will cause inconvenience to the user.

### SUMMARY

According to various embodiments, a child carrier is provided.

A child carrier is provided. The child carrier includes: a frame having a folded state; and a lower leg resting assembly connected to the frame. When the frame is in the folded state, the lower leg resting assembly is used as a carrying handle for lifting and pulling the frame.

In an embodiment, the frame includes a seated plate. The lower leg resting assembly is connected to a front side of the seated plate.

In an embodiment, the lower leg resting assembly is pivotally connected to the front side of the seated plate.

In an embodiment, the lower leg resting assembly includes a first connecting rod, a second connecting rod, and a lower leg supporting member. An end of the first connecting rod and an end of the second connecting rod are respectively pivotally connected to two ends of the seated plate at the front side. Two ends of the lower leg supporting member are respectively connected to another end of the first connecting rod and another end of the second connecting rod.

In an embodiment, the lower leg supporting member is made of a material different from that of the first connecting rod or the second connecting rod.

In an embodiment, the lower leg supporting member includes a soft material.

In an embodiment, the lower leg supporting member is a webbing.

In an embodiment, the lower leg resting assembly further includes a reinforcing member. The reinforcing member is arranged on a middle of the webbing.

In an embodiment, the lower leg supporting member is a rigid supporting rod.

In an embodiment, a buffering sleeve is sleeved on the outside of the lower leg supporting member.

In an embodiment, the frame further includes a handle, a front foot supporting rod, and a rear foot supporting rod. The front foot supporting rod and the rear foot supporting rod are pivotally connected to a bottom end of the handle.

In an embodiment, the handle, the front foot supporting rod, and the rear foot supporting rod are arranged on left and right sides of the seated plate. Two front foot supporting rods are respectively connected to the left and right sides of the seated plate.

In an embodiment, the frame further includes an engaging base. The engaging base is configured to be engaged with and fix a removable carrier.

In an embodiment, the engaging base is arranged on two handles.

### BRIEF DESCRIPTION OF THE DRAWINGS

FIG. 1 is a structural schematic view of a child carrier according to an embodiment of the present disclosure, with a frame in an unfolded state, and a lower leg resting assembly at a first position.

FIG. 2 is another structural schematic view of the child carrier shown in FIG. 1, with the frame in the unfolded state, and the lower leg resting assembly at a second position.

FIG. 3 is a structural schematic view of the child carrier shown in FIG. 2 provided with a baby basket.

FIG. 4 is another structural schematic view of the child carrier 1 shown in FIG. 1, with the frame in a semi-unfolded state.

FIG. 5 is another structural schematic view of the child carrier 1 shown in FIG. 1, with the frame in a folded state.

FIG. 6 is a structural schematic view of a child carrier according to another embodiment of the present disclosure, with a frame in an unfolded state, and a lower leg resting assembly at a first position.

FIG. 7 is another structural schematic view of the child carrier shown in FIG. 6, with the frame in the unfolded state, and the lower leg resting assembly at a second position.

FIG. 8 is a structural schematic view of the child carrier shown in FIG. 7 provided with a baby basket.

FIG. 9 is another structural schematic view of the child carrier shown in FIG. 6, with the frame in a semi-unfolded state.

FIG. 10 is another structural schematic view of the child carrier shown in FIG. 6, with the frame in a folded state.

Illustration for reference signs:
1: child carrier; 100: frame; 110: seated plate; 111: seat tube; 111a: first seat rod; 111b: second seat rod; 111c: cross rod; 112: plate body; 120: handle; 121: first handle rod; 122: second handle rod; 120a: handle body; 130: front foot supporting rod; 140: rear foot supporting rod; 150: engaging base; 160: locking mechanism; 170: operating member; 180: connecting member; 190: wheel assembly; 200: lower leg resting assembly; 210: first connecting rod; 220: second connecting rod; 230: lower leg supporting member; 240: reinforcing member; 250: buffering sleeve; and 2: removable carrier.

### DETAILED DESCRIPTION OF THE EMBODIMENTS

In order to make the object, technical solution and advantages of the present disclosure clearer, the present disclosure will be further described in detail below in conjunction with the accompanying drawings and specific embodiments. It should be understood that the specific embodiments described herein are only used to explain the present disclosure, and do not limit the protection scope of the present disclosure.

It should be noted that when an element is referred to as being “fixed” to another element, it can be directly on the other element or an intermediate element may also be present. When an element is referred to as being “connected to” another element, it can be directly connected to the other element or an intermediate element may also be present at the same time. The terms “vertical,” “horizontal,” “left,” “right,” and similar expressions are used herein for purposes of illustration only and are not intended to represent the only embodiments.

Unless otherwise defined, all technical and scientific terms used herein have the same meaning as commonly understood by one of ordinary skill in the technical field of the present disclosure. The terminology used herein in the description of the present disclosure is only for the purpose of describing specific embodiments, and is not intended to limit the present disclosure. As used herein, the term “and/or” includes any and all combinations of one or more of the associated listed items.

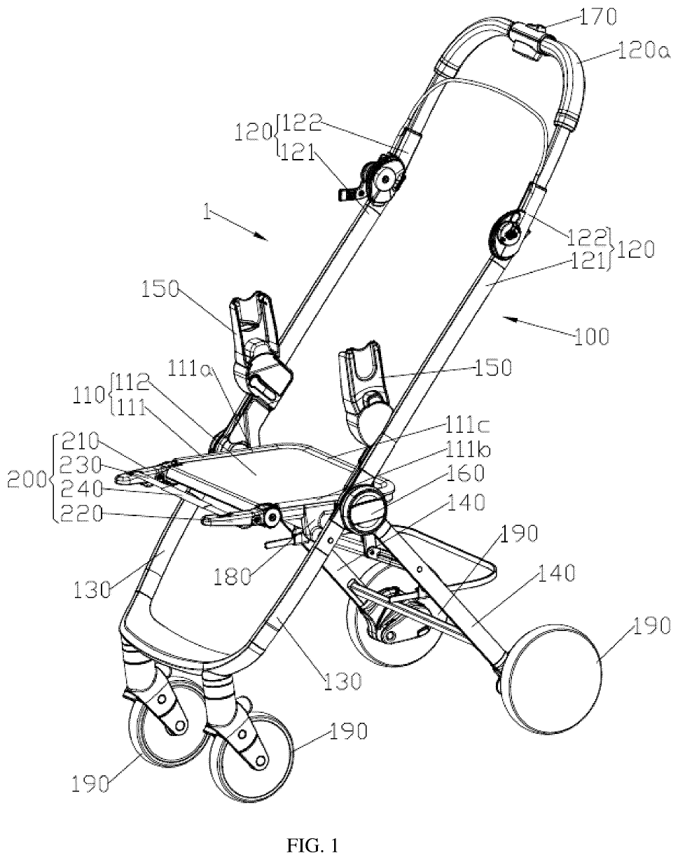

As shown in FIG. 1, an embodiment of the present disclosure provides a child carrier 1. The child carrier 1 includes a frame 100 and a lower leg resting assembly 200. After being folded, the child carrier 1 can be easily carried without any additional carrying device or carrying handle, which saves costs, is convenient for traveling, and does not affect the appearance. The foldable child carrier 1 on the market is generally equipped with an additional carrying device or carrying handle, which on the one hand, increases the manufacturing cost of the child carrier 1, and on the other hand, requires carrying the additional carrying device or carrying handle, thereby causing inconvenience to the user, and affecting the overall appearance of child carrier 1.

Specifically, the frame 100 includes a seated plate 110, a handle 120, a front foot supporting rod 130, a rear foot supporting rod 140, an engaging base 150, a locking mechanism 160, an operating member 170, a pulling member (not shown in the figures), and a wheel assembly 190.

Further, there are two handles 120, two front foot supporting rods 130, and two rear foot supporting rods 140 respectively arranged on two sides of the seated plate 110. The front foot supporting rod 130 and the rear foot supporting rod 140 positioned on either one of sides of the seated plate 110 are both pivotally connected to a bottom end of the handle 120 on the same side. Bottom ends of the two front foot supporting rods 130 and the two rear foot supporting rods 140, that is, the ends away from the handle 120, are provided with wheel assemblies 190. Each handle 120 includes a first handle rod 121, and a second handle rod 122 pivotally connected to the first handle rod 121. The first handle rod 121 is positioned below the second handle rod 122. The seated plate 110 includes a seat tube 111 and a plate body 112 arranged on the seat tube 111. In this embodiment, the seat tube 111 is a U-shaped tube. The U-shaped tube includes a first seat rod 111a, a second seat rod 111b, and a cross rod 111c. The cross rod 111c is positioned on the rear side of the seated plate 110. The first seat rod 111a and the second seat rod 111b are respectively connected to two ends of the cross rod 111c. The first seat rod 111a and the second seat rod 111b are respectively connected to the two front foot supporting rods 130. Specifically, the frame 100 may further include two connecting members 180. An end of each connecting member 180 is pivotally connected to one of the front foot supporting rods 130, and another end of each connecting member 180 is sleeved on the seat tube 111 on the same side.

Further, there are two engaging bases 150. The two engaging bases 150 are respectively arranged on the two handles 120. Both left and right sides of a removable carrier 2 are provided with engaging parts (not shown in the figures) that are removably engaged with the engaging bases 150. The removable carrier 2 can be fixed on the frame 100 through the engagement of the engaging part with the engaging base 150. The removable carrier 2 can be, for example, a baby basket or a storage basket.

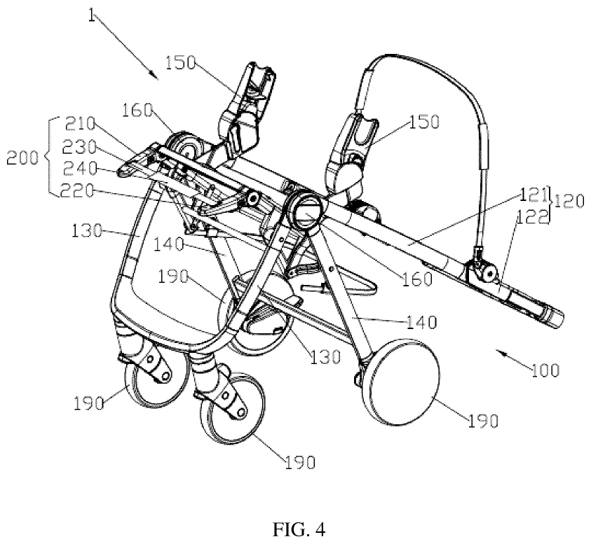

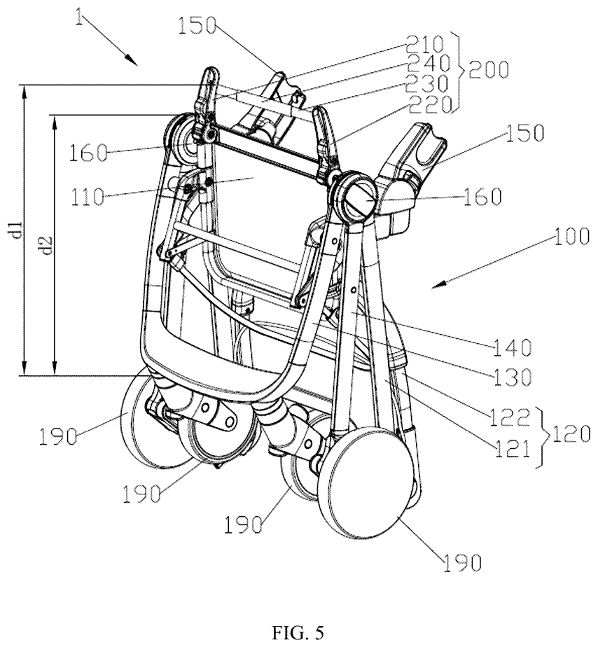

As shown in FIGS. 1 and 5, the frame 100 has an unfolded state and a folded state. Taking the handle 120, the front foot supporting rod 130, and the rear foot supporting rod 140 positioned on either one of the sides of the seated plate 110 as an example, the handle 120, the front foot supporting rod 130, and the rear foot supporting rod 140 can be pivoted to one another through the locking mechanism 160. Top ends of the two handles 120 are connected with a handle body 120a. The handle body 120a is provided with an operating member 170. Two ends of the pulling member are respectively connected to the operating member 170 and the locking mechanism 160. By operating the operating member 170, the locking mechanism 160 can be pulled by the pulling member to release the locking, thereby releasing the locking among the handle 120, the front foot supporting rod 130, and the rear foot supporting rod 140. As shown in FIGS. 4 and 5, in this case, both the front foot supporting rod 130 and the handle 120 can be rotated and folded toward a direction close to the rear foot supporting rod 140, and the second handle rod 122 can also be rotated and folded relative to the first handle rod 121 to a state in which the second handle rod 122 is substantially parallel to the first handle rod 121, thereby realizing the transformation of the frame 100 from the unfolded state to the folded state. Certainly, in another embodiment, when the frame 100 is in the folded state, the front foot supporting rod 130 and the rear foot supporting rod 140 may also be substantially parallel to each other. In another embodiment, an angle formed between the front foot supporting rod 130 and the rear foot supporting rod 140 when the frame 100 is in the folded state, is smaller than an angle formed between the front foot supporting rod 130 and the rear foot supporting rod 140 when the frame 100 is in the unfolded state. In another embodiment, an angle formed between the second handle rod 122 and the rear foot supporting rod 140 when the frame 100 is in the folded state, is smaller than an angle formed between the second handle rod 122 and the rear foot supporting rod 140 when the frame 100 is in the unfolded state. When the frame 100 is in the unfolded state, the angle formed between the second handle rod 122 and the rear foot supporting rod 140 is approximately 180 degrees.

Specifically, the lower leg resting assembly 200 includes a first connecting rod 210, a second connecting rod 220, and a lower leg supporting member 230.

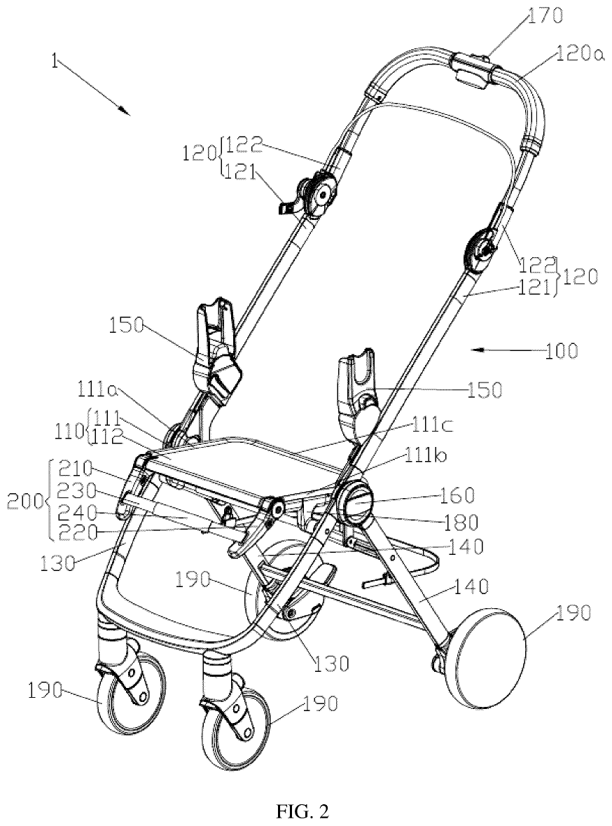

An end of the first connecting rod 210 and an end of the second connecting rod 220 are respectively pivotally connected to the two ends of the seated plate 110 at the front side, that is, respectively pivotally connected to the ends of the first seat rod 111a and the second seat rod 111b away from the cross rod 111c. Two ends of the lower leg supporting member 230 are respectively connected to the first connecting rod 210 and the second connecting rod 220. The lower leg supporting member 230 is used to support lower legs of the child. In this way, angles of the first connecting rod 210 and the second connecting rod 220 relative to the seated plate 110 can be adjusted as required, so that the lower leg supporting member 230 can better support the lower legs of babies of different ages or body shapes. For example, when the child is too young and can only ride in the child carrier 1 in a supine position, the lower leg resting assembly 200 can be rotated to a first position approximately parallel to the seated plate 110, as shown in FIG. 1. When the child is older and can ride in the child carrier 1 in a sitting position, the lower leg resting assembly 200 can be rotated to a second position at a certain inclination angle with the seated plate 110, as shown in FIG. 2. Certainly, in other embodiments, the first connecting rod 210 and the second connecting rod 220 may also be fixedly connected to two ends of the seated plate 110 at the front side, respectively.

Further, as shown in FIG. 5, when the frame 100 is in the folded state, the lower leg resting assembly 200 is positioned above the frame 100. In this case, the lower leg resting assembly 200 can be used as a carrying handle for lifting and pulling the frame 100, that is, the user can easily carry the frame 100 by lifting and pulling the lower leg supporting member 230, without any additional carrying device or carrying handle, which saves cost, facilitates travelling, and does not affect the overall appearance of the child carrier 1. A distance d1 from the lower leg supporting member 230 to the wheel assembly 190 is greater than a distance d2 from the locking mechanism 160 to the wheel assembly 190. In the folded state, the first connecting rod 210 and the second connecting rod 220 cannot pivot relative to the seated plate 110, which can facilitate the user to lift and pull the lower leg supporting member 230, to avoid that the lifting or pulling force by the user is dispersed to cause more effort due to the lower leg resting assembly 200 shaking from side to side. When the frame 100 is in the unfolded state, an angle formed between the first connecting rod 210 and the first seat rod 111a is approximately 180 degrees; or an angle formed between the second connecting rod 220 and the second seat rod 111b is approximately 180 degrees.

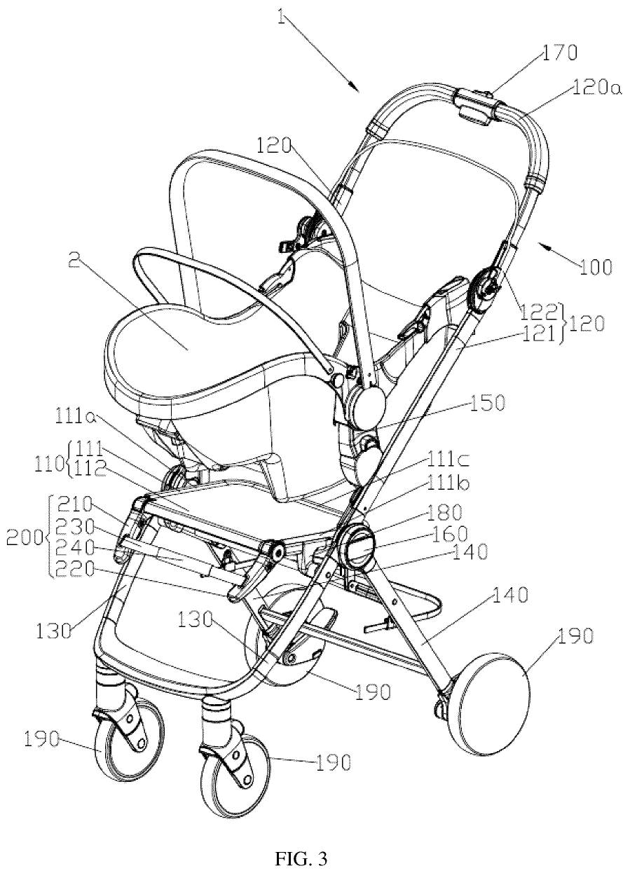

Optionally, the lower leg supporting member 230 is made of a material different from that of the first connecting rod 210 or the second connecting rod 220. In this embodiment, as shown in FIGS. 1 to 5, the lower leg supporting member 230 may be a webbing. The webbing is used as the lower leg supporting member 230, the weight is light, and the cost is low. The lower leg resting assembly 200 may further include a reinforcing member 240. In this embodiment, the reinforcing member 240 is a leather reinforcing piece sewn on approximately the middle of the webbing. The reinforcing member 240 can increase the strength of the webbing, prevent the webbing from being broken and damaged during the lifting and pulling processes, and can also improve the comfort of the consumer carrying the child carrier 1 and make the child carrier 1 more beautiful. Certainly, the lower leg supporting member 230 can also be made of other soft materials, such as nylon, linen, and cotton.

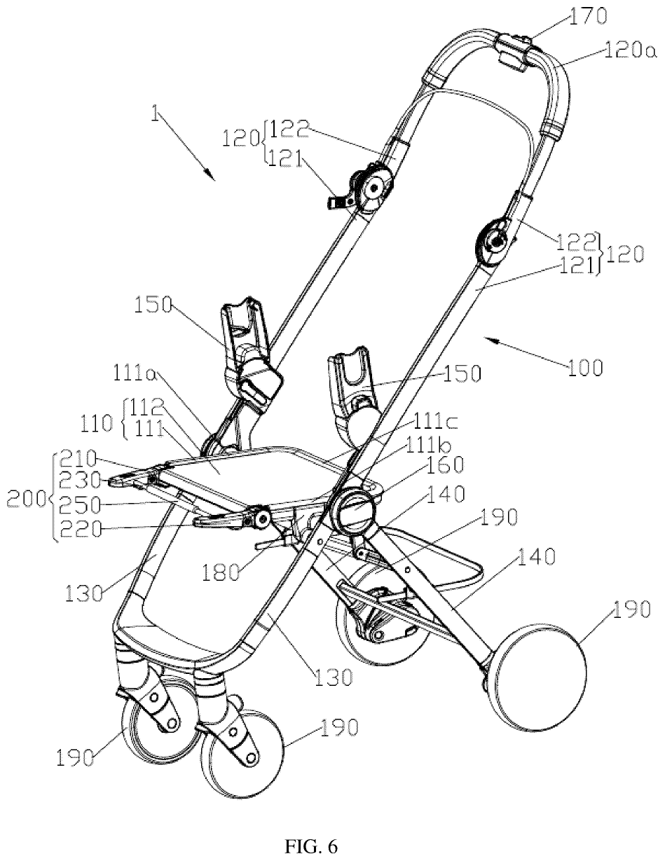

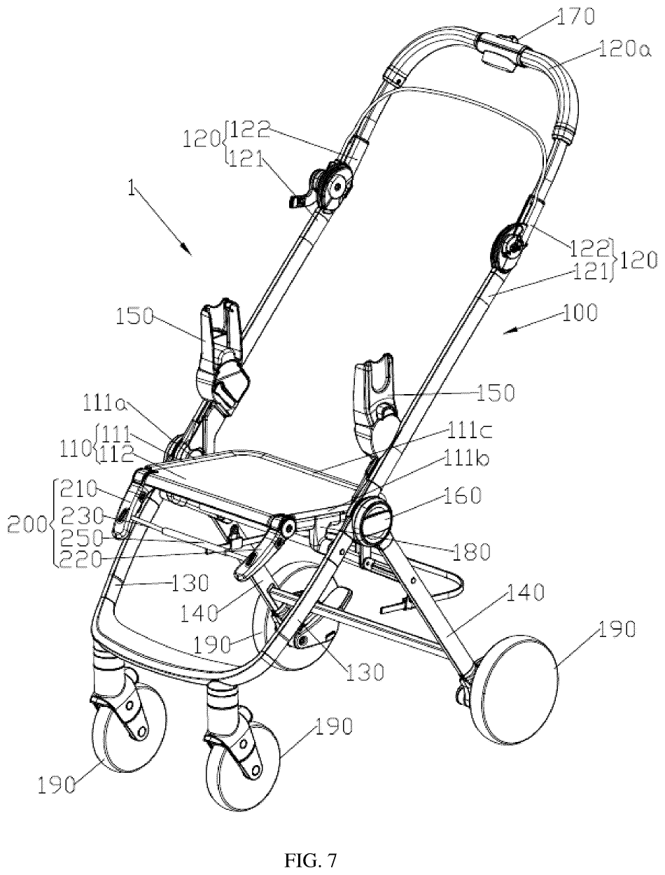

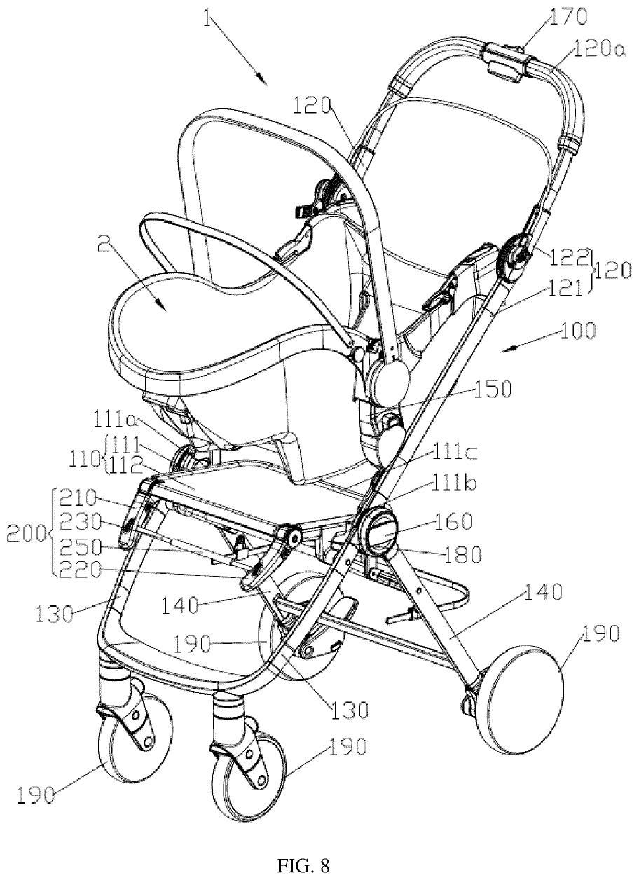

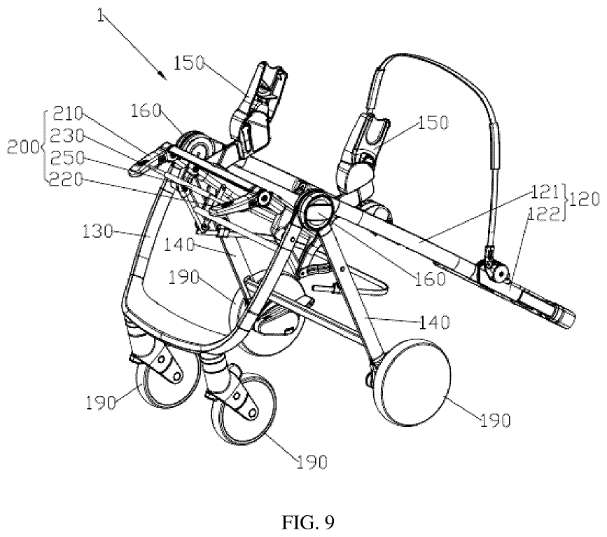

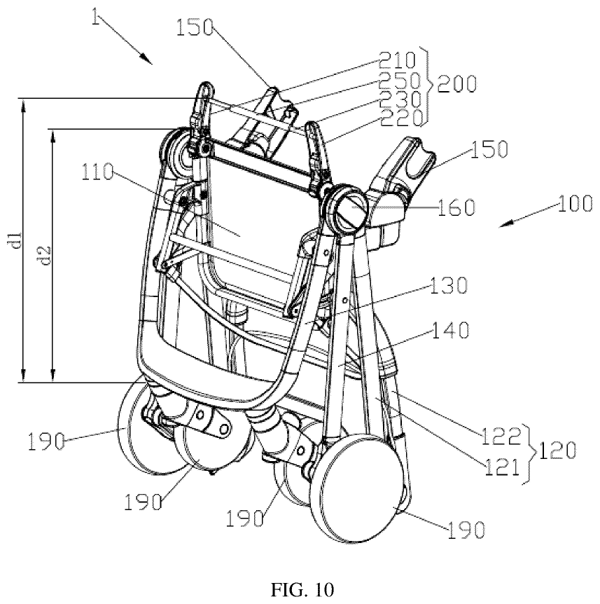

In another embodiment, as shown in FIGS. 6 to 10, the lower leg supporting member 230 can also be a rigid supporting rod, such as a rigid supporting rod made of stainless steel or plastic material. A buffering sleeve 250, such as a buffering sleeve 250 made of a silicone material, can also be sleeved on the outside of the rigid supporting rod, so as to improve the user's comfort when lifting and pulling the frame 100. Certainly, the lower leg supporting member 230 can also be made of other hard materials.

The above child carrier 1 has at least the following technical effects.

In the child carrier 1, the lower leg resting assembly 200 is connected to the frame 100. When the frame 100 is in the unfolded state, the lower leg resting assembly 200 can be used to support the child's lower legs. When the frame 100 is in the folded state, the lower leg resting assembly 200 can be used as a carrying handle for carrying the frame 100. In this way, two functions of supporting the lower legs, and lifting and pulling the frame 100 can be realized through one lower leg resting assembly 200, getting a double advantage. Moreover, additional carrying devices or carrying handles can be omitted, which not only saves costs but also facilitates travelling, and does not affect the overall appearance of the child carrier 1.

The technical features of the above-described embodiments can be combined arbitrarily. To simplify the description, not all possible combinations of the technical features in the above embodiments are described. However, all of the combinations of these technical features should be considered as being fallen within the scope of the present disclosure, as long as such combinations do not contradict with each other.

The foregoing embodiments merely illustrate some embodiments of the present disclosure, and descriptions thereof are relatively specific and detailed. However, it should not be understood as a limitation to the patent scope of the present disclosure. It should be noted that, a person of ordinary skill in the art may further make some variants and improvements without departing from the concept of the present disclosure, and the variations and improvements falls in the protection scope of the present disclosure. Therefore, the protection scope of the present disclosure shall be subject to the appended claims.

What is claimed is:

1. A child carrier comprising:
a frame having a folded state; and
a lower leg resting assembly connected to the frame;
wherein when the frame is in the folded state, the lower leg resting assembly is used as a carrying handle for lifting and pulling the frame.

2. The child carrier according to claim 1, wherein the frame comprises a seated plate, and the lower leg resting assembly is connected to a front side of the seated plate.

3. The child carrier according to claim 2, wherein the lower leg resting assembly is pivotally connected to the front side of the seated plate.

4. The child carrier according to claim 2, wherein the lower leg resting assembly comprises a first connecting rod, a second connecting rod, and a lower leg supporting member;
wherein an end of the first connecting rod and an end of the second connecting rod are respectively pivotally connected to two ends of the seated plate at the front side; and
wherein two ends of the lower leg supporting member are respectively connected to another end of the first connecting rod and another end of the second connecting rod.

5. The child carrier according to claim 4, wherein the lower leg supporting member is made of a material different from that of the first connecting rod or the second connecting rod.

6. The child carrier according to claim 5, wherein the lower leg supporting member comprises a soft material.

7. The child carrier according to claim 6, wherein the lower leg supporting member is a webbing.

8. The child carrier according to claim 7, wherein the lower leg resting assembly further comprises a reinforcing member; and
wherein the reinforcing member is arranged on a middle of the webbing.

9. The child carrier according to claim 4, wherein the lower leg supporting member is a rigid supporting rod.

10. The child carrier according to claim 9, wherein a buffering sleeve is sleeved on the outside of the lower leg supporting member.

11. The child carrier according to claim 2, wherein the frame further comprises a handle, a front foot supporting rod, and a rear foot supporting rod; and
wherein the front foot supporting rod and the rear foot supporting rod are pivotally connected to a bottom end of the handle.

12. The child carrier according to claim 11, wherein the handle, the front foot supporting rod, and the rear foot supporting rod are arranged on left and right sides of the seated plate; and
wherein two front foot supporting rods are respectively connected to the left and right sides of the seated plate.

13. The child carrier according to claim 11, wherein the frame further comprises an engaging base; and
wherein the engaging base is configured to be engaged with and fix a removable carrier.

14. The child carrier according to claim 13, wherein the engaging base is arranged on two handles.
